(19) United States
(12) Patent Application Publication
(10) Pub. No.: US 2010/0146454 A1
(43) Pub. Date: Jun. 10, 2010

(54) POSITION-DEPENDENT INFORMATION REPRESENTATION SYSTEM, POSITION-DEPENDENT INFORMATION REPRESENTATION CONTROL DEVICE, AND POSITION-DEPENDENT INFORMATION REPRESENTATION METHOD

(76) Inventors: Hiroto Sugahara, Tokyo (JP); Takashi Ono, Tokyo (JP); Kayato Sekiya, Tokyo (JP)

Correspondence Address: Mr. Jackson Chen, 6535 N. STATE HWY 161, IRVING, TX, 75039, US

(21) Appl. No.: 12/443,555

(22) PCT Filed: Nov. 29, 2007
(86) PCT No.: PCT/JP2007/073009

§ 371 Date: Mar. 30, 2009

(30) Foreign Application Priority Data
Dec. 1, 2006 (JP) 2006-325495

(51) Int. Cl. G06F 3/048

(52) U.S. Cl. 715/859

(57) ABSTRACT

The present invention is intended to provide a position-dependent information representation system which can allow persons other than evaluators to readily recognize at which positions the respective evaluators are evaluating information. Control device causes map/layout display means to display a map or a layout chart of a specified area in according to an instruction of the evaluator, and specifies an evaluation point specified by the evaluator in the display range of the map or the layout chart displayed according to an instruction of the evaluator. Information acquiring means acquires information data representing information of the evaluation point. Information representation section represents the information data. ID receiving means and information representation section connected to control device are connected through communication medium, such that the correspondence of the evaluation point to information representation section can be visually recognized, and information acquiring means transmits the acquired information data to information representation section.

### TECHNICAL FIELD

The present invention relates to a position-dependent information representation system, a position-dependent information representation control device, and a position-dependent information representation method for representing information in accordance with a position, and to a position-dependent information representation system, a position-dependent information representation control device, and a position-dependent information representation method which allow a plurality of evaluators to specify different positions simultaneously on a displayed map or layout chart to represent information.

### BACKGROUND ART

In planning and designing for facilities of a communication network in a radio communication system, present characteristic information must be evaluated using an evaluation system and device in order to identify a problematic area which should be accounted for, or in order to verify effects resulting from a change in facilities and designing conditions.

Characteristic information of a radio communication system may include a variety of items such as radio wave intensity, delay expansion, user feeing quality and the like. They are all variable depending on (in accordance with) the location of a mobile terminal. For this reason, in a preferred implementation, characteristic information at each location may be represented on a map, when outdoors, or on a layout chart, when indoors in correspondence thereto.

As approaches for representing such position-dependent information on a map or a layout chart, in one implementation, a position has been specified on a map or a layout chart using a mouse or the like to display the position-dependent information. For example, on a web site “Google (Registered Trade Mark) Earth” on which an aerial photo can be viewed on the Internet, a position is specified by a mouse pointer to display information such as the latitude, longitude, and altitude of that position near an edge of the screen.

In this regard, JP-2005-267500-A describes a technique for displaying an image indicative of a pointer at a position specified by the pointer on a screen.

### DISCLOSURE OF THE INVENTION

### Problems to be Solved by the Invention

In an implementation where information is represented for a position specified by a mouse, an evaluator himself who has specified a position per se can readily recognize where the specified position is, but persons other than the evaluator who are viewing the same screen must find a mouse point located within the screen in order to recognize the position specified by the evaluator. Particularly, when a plurality of evaluators simultaneously evaluate information, an individual mouse pointer and a display for information at the mouse pointer should be prepared for each evaluator, but persons other than the evaluators encounter difficulties in discriminating which display corresponds to which mouse pointer.

For example, assume a situation where a plurality of persons cooperate to plan or design facilities of a communication network using a map displayed on the screen of a large display. In such a situation, it is contemplated that a plurality of evaluators extract evaluation points from viewpoints of the evaluators themselves and simultaneously evaluate characteristic information at positions different from one another. When characteristic information is to be evaluated by a plurality of persons using the approach mentioned above, it is difficult to discriminate at which positions the respective evaluators are evaluating the characteristic information. As a result, problems and effects resulting from a change in facilities and design conditions cannot be smoothly shared among members who participate in the facility planning or designing.

It is therefore an object of the present invention to provide a position-dependent information representation system, a position-dependent information representation control device, and position-dependent information representation method which are capable of allowing a person other than evaluators to readily recognize at which positions the respective evaluators are evaluating information.

### Means for Solving the Problem

A position-dependent information representation system according to the present invention is a position-dependent information representation system for representing information in accordance with a position, which comprises control means for causing display means to display a map or a layout chart of a specified region in accordance with instructions of an evaluator, and specifying an evaluation point which is a position specified by the evaluator within a display range of the map or layout chart displayed on the display means in accordance with instructions of the evaluator, information acquiring means for acquiring information data indicative of information of the evaluation point, and position-dependent information representing means for representing the information data, wherein the control means and the position-dependent information representing means are connected through a communication medium such that a correspondence of the evaluation point to the position-dependent information representing means can be visually recognized, and the information acquiring means transmits the acquired information data to the position-dependent information representing means.

Also, a position-dependent information representation system according to the present invention is a position-dependent information representation system for representing information in accordance with a position, which comprises control means for causing display means to display a map or a layout chart of a specified region in accordance with instructions of an evaluator, and specifying an evaluation point which is a position specified by the evaluator within a display range of the map or layout chart displayed on the display means in accordance with instructions of the evaluator, information acquiring means for acquiring information data indicative of information of the evaluation point, and position-dependent information representing means for representing the information data, wherein the position-dependent information representing means includes representing means ID transmitting means for transmitting an representing means ID to the control means for distinguishing from other position-dependent information representing means, the representing means ID transmitting means transmits a representing means ID to the control means, the information acquiring means transmits the acquired information data and the representing means ID transmitted to the control means to the position-dependent information representing means, the position-dependent information representing means represents the information data transmitted thereto when the transmitted representing means ID matches its own representing means ID.

Also, a position-dependent information representation system according to the present invention is a position-dependent information representation system for representing information in accordance with a position, which comprises control means for causing display means to display a map or a layout chart of a specified region in accordance with instructions of an evaluator, and specifying an evaluation point which is a position specified by the evaluator within a display range of the map or layout chart displayed on the display means in accordance with instructions of the evaluator, evaluation point ID specifying means for specifying an evaluation point ID for identifying an evaluation point in accordance with instructions of the evaluator, information acquiring means for acquiring information data indicative of information of the evaluation point, and position-dependent information representing means for representing the information data, wherein the information acquiring means transmits the acquired information data and the evaluation point ID specified by the evaluation point ID specifying means to the position-dependent information representing means, and the position-dependent information representing means includes ID selecting means for selecting a representing means ID for distinguishing from other position-depending information representing means in accordance with instructions of the evaluator, and represents the information data transmitted thereto when the transmitted evaluation point ID matches the representing means ID selected by the ID selecting means.

A position-dependent information representation control device according to the present invention is a position-dependent information representation control device for representing information in accordance with a position, which comprises control means connected to position-dependent information representing means for representing information data, for causing display means to display a map or a layout chart of a specified region in accordance with instructions of an evaluator, and specifying an evaluation point which is a position specified by the evaluator within a display range of the map or layout chart displayed on the display means in accordance with instructions of the evaluator, and information acquiring means for acquiring information data indicative of information of the evaluation point, wherein the control means and the position-dependent information representing means are connected through a communication medium such that a correspondence of the evaluation point to the position-dependent information representing means can be visually recognized, and the information acquiring means transmits the acquired information data to the position-dependent information representing means.

Also, a position-dependent information representation control device according to the present invention is a position-dependent information representation control device for representing information in accordance with a position, which comprises control means connected to position-dependent information representing means for representing information data, for causing display means to display a map or a layout chart of a specified region in accordance with instructions of an evaluator, and specifying an evaluation point which is a position specified by the evaluator within a display range of the map or layout chart displayed on the display means in accordance with instructions of the evaluator, information acquiring means for acquiring information data indicative of information at the evaluation point, and representing means ID receiving means for receiving a representing means ID from position-dependent information representing means for distinguishing the position-dependent information representing means from other position-dependent information representing means, wherein the information acquiring means transmits the acquired information data and the representing means ID received by the representing means ID receiving means to the position-dependent information representing means.

Also, a position-dependent information representation control device according to the present invention is a position-dependent information representation control device for representing information in accordance with a position, which comprises control means for causing display means to display a map or a layout chart of a specified region in accordance with instructions of an evaluator, and specifying an evaluation point which is a position specified by the evaluator within a display range of the map or layout chart displayed on the display means in accordance with instructions of the evaluator, evaluation point ID specifying means for specifying an evaluation point ID for identifying an evaluation point in accordance with instructions of the evaluator, and information acquiring means for acquiring information data indicative of information of the evaluation point, wherein the information acquiring means transmits the acquired information data and the evaluation point ID specified by the evaluation point ID specifying means to position-dependent information representing means for representing the information data.

A position-dependent information representation method according to the present invention is a position-dependent information representation method for representing information in accordance with a position, which comprises a control step of causing display means to display a map or a layout chart of a specified region in accordance with instructions of an evaluator, and specifying an evaluation point which is a position specified by the evaluator within a display range of the map or layout chart displayed on the display means in accordance with instructions of the evaluator, an information acquiring step of acquiring information data indicative of information of the evaluation point, and an information representing step of representing the information data by position-dependent information representing means, wherein the information data acquired at the information acquiring step is transmitted to the position-dependent information representing means.

Also, a position-dependent information representation method according to the present invention is a position-dependent information representation method for representing information in accordance with a position, which is characterized by comprising a control step of causing display means to display a map or a layout chart of a specified region in accordance with instructions of an evaluator, and specifying an evaluation point which is a position specified by the evaluator within a display range of the map or layout chart displayed on the display means in accordance with instructions of the evaluator, a representing means ID transmitting step of transmitting an representing means ID from position-dependent information representing means to the control means for distinguishing from other position-dependent information representing means, an information acquiring step of acquiring information data indicative of information of the evaluation point, and an information representing step of representing the information data by the position-dependent information representing means, wherein the information acquiring step includes transmitting the acquired information data and the representing means ID received by the control means to the position-dependent information representing means, and the information representing step includes the position-dependent information representing means representing the information data transmitted thereto when the transmitted representing means ID matches its own representing means ID.

Also, a position-dependent information representation method according to the present invention is a position-dependent information representation method for representing information in accordance with a position, which comprises a control step of causing display means to display a map or a layout chart of a specified region in accordance with instructions of an evaluator, and specifying an evaluation point which is a position specified by the evaluator within a display range of the map or layout chart displayed on the display means in accordance with instructions of the evaluator, an information acquiring step for acquiring information data indicative of information of the evaluation point, and an information representing step of representing the information data by position-dependent information representing means, wherein the control step includes specifying an evaluation point ID for identifying an evaluation point in accordance with instructions of the evaluator, the information acquiring step includes transmitting the acquired information data and the evaluation point ID specified at the control step to the position-dependent information representing means, and the information representing step includes selecting a representing means ID for distinguishing from other position-dependent information representing means in accordance with instructions of the evaluator, and representing the transmitted information data when the transmitted evaluation point ID matches the representing means ID selected at the ID selecting step.

According to the present invention, the control means and position-dependent information representing means are connected through a communication medium such that the correspondence of an evaluation point to the position-dependent information representing means can be visually recognized, and relevant information is represented only by the position-dependent information representing means to which information data is transmitted through the communication medium, so that persons other than evaluators can be allowed to readily recognize at which positions the respective evaluators are evaluating information. As a result, in a situation where a plurality of persons plan or design facilities of a network in common using a map displayed on a large display, it is possible to smoothly share problems and effects resulting from a change in facilities and design conditions among members who participate in the facility planning and designing.

### BRIEF DESCRIPTION OF THE DRAWINGS

FIG. 1 A block diagram showing the configuration of a first exemplary embodiment of a position-dependent information representation system.

FIG. 2 A flow chart showing the operation of the first exemplary embodiment of the position-dependent information representation system.

FIG. 3 A block diagram showing an exemplary configuration of a position-dependent information representation system when a plurality of evaluators simultaneously evaluate information at different evaluation points.

FIG. 4 A block diagram showing the configuration of a second exemplary embodiment of a position-dependent information representation system.

FIG. 5 A flow chart showing the operation of the second exemplary embodiment of the position-dependent information representation system.

FIG. 6 A block diagram showing the configuration of a third exemplary embodiment of a position-dependent information representation system.

FIG. 7 A flow chart showing the operation of the third exemplary embodiment of the position-dependent information representation system.

FIG. 8 A block diagram showing the configuration of a fourth exemplary embodiment of a position-dependent information representation system.

FIG. 9 A flow chart showing the operation of the fourth exemplary embodiment of the position-dependent information representation system.

FIG. 10 A block diagram showing the configuration of a fifth exemplary embodiment of a position-dependent information representation system.

FIG. 11 A flow chart showing the operation of the fifth exemplary embodiment of the position-dependent information representation system.

### BEST MODE FOR CARRYING OUT THE INVENTION

### First Exemplary Embodiment

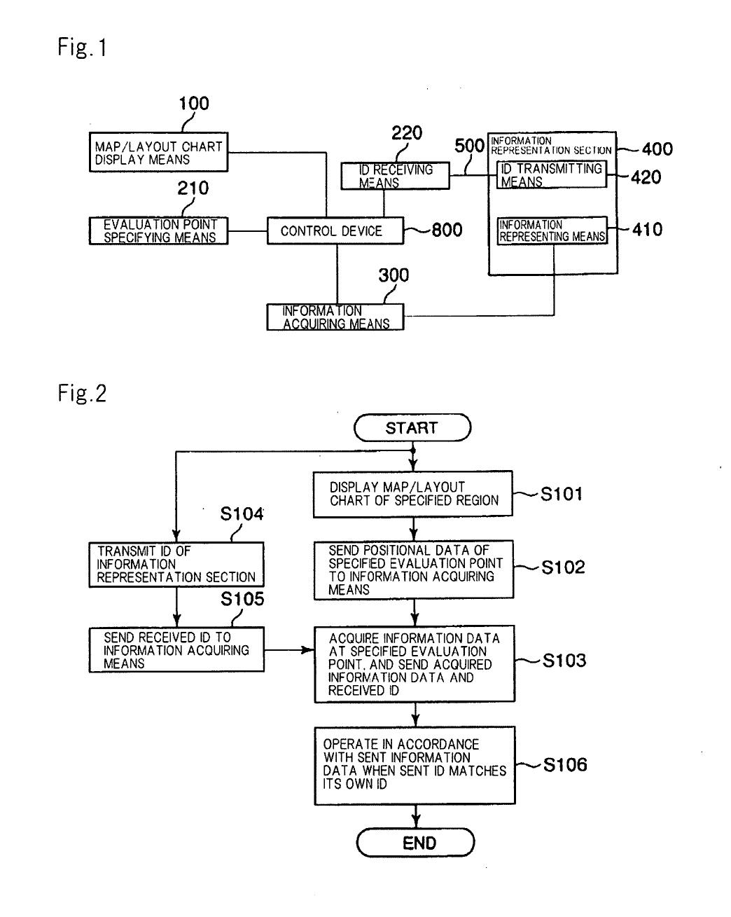

A first exemplary embodiment of the present invention will be described with reference to the drawings. FIG. 1 is a block diagram showing the configuration of a first exemplary embodiment of a position-dependent information representation system according to the present invention. As shown in FIG. 1, the position-dependent information representation system of the first exemplary embodiment comprises control device (control means) 800 for controlling connected map/layout chart display means (display means) 100, evaluation point specifying means 210, and ID receiving means 220; information acquiring mean 300; and information representation section (position-dependent information representing means) 400. As can be seen, ID receiving means 220 and information representation section 400 are connected through communication medium 500.

Map/layout chart display means 100 has a function of displaying a map or a layout chart of a specified region based on map data or layout chart data extracted from a map/layout chart DB (not shown), which stores map data or layout chart data, in accordance with control of control device 800 operated by an evaluator.

Map/layout chart display means 100 is, for example, a touch panel, a monitor such as a CRT (Cathode Ray Tube) display, a TFT (Thin Film Transistor) liquid crystal display or the like, or a screen, a table or the like on which a map or a layout chart is projected by a projector.

Evaluation point specifying means 210 has a function of specifying a position at which the evaluator evaluates position-dependent information such as a communication quality and the like (evaluation point) within a range of a map or a layout chart displayed on map/layout chart display means 100. In this regard, in the following, when control device 800 specifies an evaluation point in accordance with an operation performed on evaluation point specifying means 210, this is also referred to as evaluation point specifying means 210 specifying an evaluation point. Here, control device 800 may specify an evaluation point based on a signal which is output by evaluation point specifying means 210 in accordance with a performed operation.

Also, control device 800 generates positional data indicative of a specified evaluation point, retrieves positional data corresponded to a position from a database which stores positional data indicative of the position, and transmits the positional data to information acquiring means 300.

ID receiving means 220 has a function of receiving an ID for identifying information representation section 400, transmitted from ID transmitting means 420 of information representation section 400, through communication medium 500.

In this regard, evaluation point specifying means 210 is, for example, a tangible device which is capable of specifying a position placed on map/layout chart display means 100 as an evaluation point. Then, this tangible device may have a function of receiving an ID for identifying the information representation section, transmitted from ID transmitting means 420 of information representation unit 400, through communication medium 500. In other words, evaluation point specifying means 210 and ID receiving means 220 may be tangible devices. Alternatively, evaluation point specifying means 210 alone may be a tangible device, while ID receiving means 220 may be disposed at a location different from the tangible device.

Also, when map/layout chart display means 100 is a touch panel, a sensor which is provided at a position corresponding to a finger tip of an evaluator who makes contact with the touch panel for detecting that the touch panel is touched by the evaluator, serves as evaluation point specifying means 210.

Information acquiring means 300 has a function of acquiring information data at an evaluation point specified by evaluation point specifying means 210 based on positional data indicative of the evaluation point. Information acquiring means 300 also has a function of sending the acquired information data to information representation section 400 together with the ID received by ID receiving means 220.

A description will be given of a method by which information acquiring means 300 acquires information data. In one method, a database is provided for storing information data in correspondence to positions, such that information acquiring means 300 extracts information data corresponding to a position specified by evaluation point specifying means 210 from the database to acquire the information data.

Alternatively, when information data can be calculated, another method may be such that information acquiring means 300 makes a calculation based on an evaluation point specified by evaluation point specifying means 210, and calculates information data at the evaluation point to acquire the information data. Specifically, when information data indicates, for example, signal reception power at a radio communication system, information acquiring means 300 makes a calculation for a radio wave simulation based on data on a base station installed in the vicinity of a specified evaluation point and map data or layout data of a region including the evaluation point to calculate the signal reception power at the evaluation point, thus acquiring the information data.

Alternatively, information acquiring means 300 may download information data from a device which is in accordance with an evaluation point specified by evaluation point specifying means 210, and connected through a communication network. Specifically, for example, in a monitoring camera control system, information acquiring means 300 downloads a video image captured by a monitoring camera which is installed at a specified evaluation point and connected to information acquiring means 300 through a communication network.

Information representation section 400 comprises information representing means 410 and ID transmitting means (representing means ID transmitting means) 420. Information representing means 410 has a function of representing information data acquired by information acquiring means 300 when the ID sent from information acquiring means 300 matches the its own ID. Representing information data refers to decoding voice data to generate a voice when information data is voice data, decoding image data to display an image when information data is image data, and so forth.

ID transmitting means 420 has a function of transmitting the ID of information representation section 400 to ID receiving means 220 through communication medium 500.

Information representation section 400 is a device for reproducing, for example, voice data or video data as the information data when a user feeling quality is evaluated from a subjective point of view in a voice communication or a video communication. ID transmitting means 420 is stored within this device. In this regard, when information representation section 400 is a mobile telephone, information representing means 410 is, for example, a display unit (liquid crystal display or the like) when video data is reproduced, or for example, a voice output unit (speaker or the like) when voice data is reproduced.

Communication medium 500 is connected to ID receiving means 220, and ID transmitting means 420 stored in information representation section 400, and has a function of communicating an ID transmitted from ID transmitting means 420 to ID receiving means 220. Communication medium 500 is, for example, a communication medium which can be visually recognized, such as a wired communication cable or the like. In this regard, when ID transmitting means 420 and ID receiving means 220 support a human-body communication, the body of an evaluator himself who is in contact with ID receiving means 220 and information representation section 400 functions as communication medium 500.

Communication medium 500 may be connected from ID transmitting means 420 to ID receiving means 220 through evaluation point specifying means 210. For example, when evaluation point specifying means 210 is a tangible device and ID receiving means 220 is located at a place different from the tangible device, ID transmitting means 420 and tangible device are connected through visually recognizable communication medium 500, so that the ID transmitted from ID transmitting means 420 is transmitted to ID receiving means 220 through the tangible device. Alternatively, when evaluation point specifying means 210 is a sensor provided at a position corresponding to a finger tip of an evaluator who makes a contact with a touch panel, ID transmitting means 420 and sensor are connected through visually recognizable communication medium 500 (in this event, the body of the evaluator himself who is in contact with both information representation section 400 and touch panel provides this function), so that the ID transmitted from ID transmitting means 420 is transmitted to ID receiving means 220 through the sensor.

Alternatively, communication medium 500 may be connected from ID transmitting means 420 to ID receiving means 220 which is stored at substantially the same place as evaluation point specifying means 210 (for example, in the vicinity of evaluation point specifying means 210).

By placing communication medium 500 in a connection form as described above, the connection of evaluation point specifying means 210 with information representation section 400 can be visually recognized, so that a correspondence relationship between an evaluation point and the information representation section can be recognized by persons other than the evaluator as well.

FIG. 2 is a flow chart showing the operation of the first exemplary embodiment of the position-dependent information representation system according to the present invention. First, control device 800 causes map/layout chart display means 100 to display a map or a layout chart of a region specified by an evaluator, based on map data or layout chart data corresponding to the region within map data or layout chart data (step S101).

Next, when evaluation point specifying means 210 is manipulated to specify an evaluation point, control device 800 acquires positional data indicative of the evaluation point specified by evaluation point specifying means 210 within the region of the map or layout chart displayed on map/layout chart display means 100, and sends the acquired positional data to information acquiring means 300 (step S102).

ID transmitting means 420 in turn transmits an ID for identifying information representation section 400 to ID receiving means 220 through communication medium 500 (step S104). ID receiving means 220 receives the ID transmitted at step S104, and outputs the same to control device 800. Control device 800 sends the ID received by ID receiving means 220 to information acquiring means 300 (step S105).

Information acquiring means 300 acquires information data at the evaluation point based on the positional data of the evaluation point sent at step S102. Then, information acquiring means 300 sends the acquired information data to information representing means 410 together with the ID sent at step S105 (step S103). Information representing means 410 performs an operation in accordance with the information data sent at step S103 to represent information data when the ID sent at step S103 matches the ID of information representation section 400 (step S106).

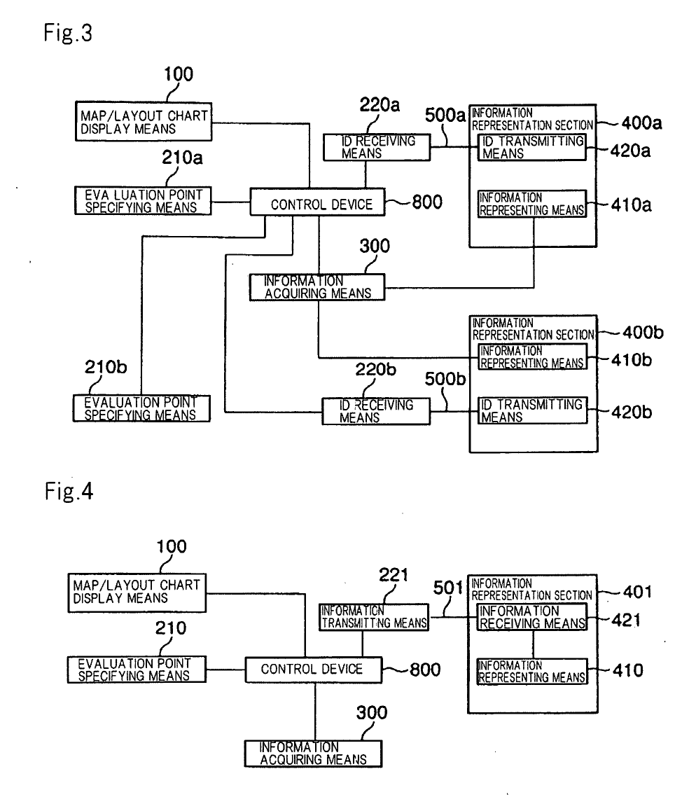

FIG. 3 is a block diagram showing an exemplary configuration of a position-dependent information representation system when a plurality of evaluators simultaneously evaluate information at different evaluation points. In the example shown in FIG. 3, assume that evaluator a specifies evaluation point a by evaluation point specifying means 210a, and evaluator b specifies evaluation point b by evaluation point specifying means 210b.

Also, ID receiving means 220a and information representation section 400a are connected through communication medium 500a so as to allow visual recognition of a correspondence of evaluation point specifying means 210a which specifies evaluation point a to information representation section 400a, while ID receiving means 220b and information representation section 400b are connected through communication medium 500b so as to allow visual recognition of a correspondence of evaluation point specifying means 210b which specifies evaluation point b to information representation section 400b.

In this regard, evaluation point specifying means 210a and evaluation point specifying means 210b are similar in configuration to evaluation point specifying means 210 shown in FIG. 1. Also, ID receiving means 220a and ID receiving means 220b are similar in configuration to ID receiving means 220 shown in FIG. 1. Further, information representation section 400a and information representation section 400b are similar in configuration to information representation section 400 shown in FIG. 1. Further, communication medium 500a and communication medium 500b are similar in configuration to communication medium 500 shown in FIG. 1.

ID transmitting means 420a transmits the ID of information representation section 400a to ID receiving means 220a through communication medium 500a. ID receiving means 220a receives the transmitted ID of information representation section 400a. Control device 800 transmits the ID of information representation section 400a received by ID receiving means 220a and positional data indicative of evaluation point a specified by evaluation point specifying means 210a to information acquiring means 300.

Information acquiring means 300 acquires information data at evaluation point a based on positional data indicative of evaluation point a. Also, information acquiring means 300 sends the acquired information data at evaluation point a and the ID of information representation section 400a received by ID receiving means 220a to information representing means 410a. Information representing means 410a represents the sent information data when the sent ID matches the ID of information representation section 400a.

ID transmitting means 420b transmits the ID of information representation section 400b to ID receiving means 220b through communication medium 500b. ID receiving means 220b receives the transmitted ID of information representation section 400b. Control device 800 transmits the ID of information representation section 400b received by ID receiving means 220b and positional data indicative of evaluation point b specified by evaluation point specifying means 210b to information acquiring means 300.

Information acquiring means 300 acquires information data at evaluation point b based on the positional data indicative of evaluation point b. Also, information acquiring means 300 sends the acquired information data at evaluation point b and the ID of information representation section 400b received by ID receiving means 220b to information representing means 410b. Information representing means 410b represents the sent information data when the sent ID matches the ID of information representation section 400b.

In the position-dependent information representation system shown in FIG. 3, the information data at evaluation point a is represented by information representing means 410a because the ID sent together with the information data matches the ID of information representation section 400a, whereas the information data at evaluation point b is not represented by information representing means 410a because the sent ID does not match the ID of information representation section 400a.

Also, in the position-dependent information representation system shown in FIG. 3, the information data at evaluation point b is represented by information representing means 410b because the ID sent together with the information data matches the ID of information representation unit 400b, whereas the information data at evaluation point a is not represented by information representing means 410b because the sent ID does not match the ID of information representation section 400b.

The connections with communication medium 500a and communication medium 500b indicate that information representing means a corresponds to evaluation point a, and information representing means b corresponds to evaluation point b, thus allowing each evaluator to readily recognize which evaluation point each information data is associated with.

Also, the connection of evaluation specifying means 210a which specifies evaluation point a with information representation section 400a is made visually recognizable, while the connection of evaluation specifying means 210b which specifies evaluation point b with information representation section 400b is made visually recognizable, so that the correspondence relationship between the evaluation points and the information representation sections can be recognized by persons other than the evaluators. In this regard, the following second to fifth exemplary embodiments show only one corresponded set of an evaluation point and an information representation section.

### Second Exemplary Embodiment

A second exemplary embodiment of the present invention will be described with reference to the drawings. FIG. 4 is a block diagram showing the configuration of the second exemplary embodiment of the position-dependent information representation system according to the present invention.

The position-dependent information representation system shown in FIG. 4 comprises control device 800 for controlling connected map/layout chart display means 100, evaluation point specifying means 210, and information transmitting means 221; information acquiring means 300, and information representation section 401. As can be seen, information transmitting means 221 and information representation section 401 are connected through communication medium 501.

In this regard, exemplary configurations and specific devices of map/layout chart display means 100, evaluation point specifying means 210, information acquiring means 300, and information representing means 410 are as shown in the description of the first exemplary embodiment.

Information transmitting means 221 has a function of transmitting information data acquired by information acquiring means 300 to information receiving means 421 through communication medium 501.

Information receiving means 421 has a function of receiving the information data transmitted from information transmitting means 221. In this regard, information representation section 401 includes information representing means 410 and information receiving means 421.

Communication medium 501 is connected to information transmitting means 221, and information receiving means 421 stored in information representation section 401, and has a function of communicating the information data transmitted from information transmitting means 221 to information receiving means 421. Communication medium 501 is, for example, a communication medium which can be visually recognized, such as a wired communication cable or the like. In this regard, when information transmitting means 221 and information receiving means 421 support a human-body communication, the body of an evaluator himself who is in contact with information transmitting means 221 and information representation section 401 functions as communication medium 501.

Communication medium 501 may be connected from information transmitting means 221 to information receiving means 421 through evaluation point specifying means 210. For example, when evaluation point specifying means 210 is a tangible device and information transmitting means 221 is located at a place different from the tangible device, the tangible device and information receiving means 421 are connected through visually recognizable communication medium 501, so that the information data transmitted from information transmitting means 221 is transmitted to information receiving means 421 through the tangible device. Alternatively, when evaluation point specifying means 210 is a sensor provided at a position corresponding to a finger tip of an evaluator who makes a contact with a touch panel, the sensor and information receiving means 421 are connected through visually recognizable communication medium 501 (in this event, the body of the evaluator himself who is in contact with both information representation section 401 and touch panel provides this function), so that the information data transmitted from information transmitting means 221 is transmitted to information receiving means 421 through the sensor.

Alternatively, communication medium 501 may be connected from information transmitting means 221 stored at substantially the same place as evaluation point specifying means 210 (for example, in the vicinity of evaluation point specifying means 210) to information receiving means 421.

By placing communication medium 501 in a connection form as described above, the connection of evaluation point specifying means 210 with information representation section 401 can be visually recognized, so that a correspondence relationship between an evaluation point and the information representation section can be recognized by persons other than the evaluator as well.

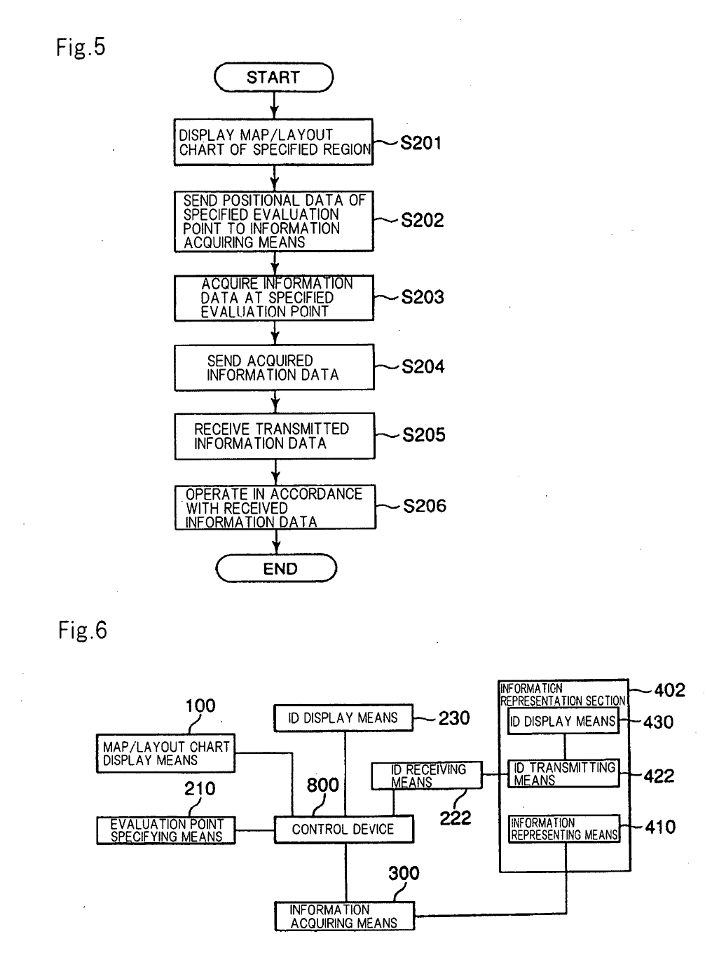

FIG. 5 is a flow chart showing the operation of the second exemplary embodiment of the position-dependent information representation system according to the present invention.

First, control device 800 causes map/layout chart display means 100 to display a map or a layout chart of a region specified by an evaluator, based on map data or layout chart data corresponding to the region within map data or layout chart data (step S201).

Next, when evaluation point specifying means 210 is manipulated to specify an evaluation point, control device 800 acquires positional data indicative of the evaluation point specified by evaluation point specifying means 210 within the region of the map or layout chart displayed on map/layout chart display means 100, and sends the acquired positional data to information acquiring means 300 (step S102).

Information acquiring means 300 acquires information data at the evaluation point based on the positional data of the evaluation point sent at step S202 (step S203). Information acquiring means 300 sends the acquired information data to information receiving means a421 of information representation section 401 through control device 800, information transmitting means 221, and communication medium 501 (step S204).

Information receiving means 421 receives the information data sent at step S204 (step S205). Information representing means 410 performs an operation in accordance with the information data received by information receiving means 421 at step S205 to represent the information data (step S206).

The position-dependent information representation system of the second exemplary embodiment transmits/receives information data through visually recognizable communication medium 501 which is connected from information transmitting means 221 installed at substantially the same position as evaluation point specifying means 210 (for example, in the vicinity of evaluation point specifying means 210) to information representation section 401 or connected from information transmitting means 221 to information representation section 401 through evaluation point specifying means 210. By taking such a form, information data at a specified evaluation point is represented by information representation section 401 connected through communication medium 501, and the correspondence relationship of the evaluation point to information representation section 401 can be recognized by persons other than an evaluator.

### Third Exemplary Embodiment

A third exemplary embodiment of the present invention will be described with reference to the drawings. FIG. 6 is a block diagram showing the configuration of the third exemplary embodiment of the position-dependent information representation system according to the present invention.

The position-dependent information representation system shown in FIG. 6 comprises control device 800 for controlling connected map/layout chart displaying means 100, evaluation point specifying means 210, ID display means (display means) 230, and ID receiving means (representing means ID receiving means) 222; information acquiring means 300; and information representation section 402.

In this regard, exemplary configurations and specific devices of map/layout chart display means 100, information representing means 410, and information acquiring means 300 are as shown in the description of the first exemplary embodiment. Also, an exemplary specific device of evaluation point specifying means 210 may be a mouse, a slide pad or the like other than the tangible device or the sensor which is provided at a position corresponding to a finger tip of an evaluator who makes a contact with a touch panel, as shown in the first exemplary embodiment.

ID receiving means 222 has a function of receiving an ID transmitted from ID transmitting means 422. ID display means 230 has a function of displaying a color, a character or the like associated with the ID in accordance with the control of control device 800 at the time the transmission/reception of the ID is completed from ID transmitting means 422 to ID receiving means 222.

In this regard, control device 800 may display a color, a character or the like associated with the ID on a light or a window provided on a tangible device as ID display means 230. Alternatively, control device 800 may display a color, a character or the like associated with the ID at or in the vicinity of a position specified by an evaluator using a tangible device or a touch panel within the screen of map/layout chart display means 100. Alternatively, a mouse pointer itself may be displayed in a color or in the form of a character or the like associated with the ID.

Information representation section 402 comprises ID display means 430, ID transmitting means 422, and information representing means 410. ID transmitting means 422 has a function of transmitting the ID of information representation section 402 to ID receiving means 222. ID display means 430 has a function of displaying a color, a character or the like associated with the ID at the time the transmission/reception of the ID is completed from ID transmitting means 422 to ID receiving means 222.

Information representation section 402 is a device for reproducing, for example, voice data or video data as the information data when a user feeling quality is evaluated from a subjective point of view in a voice communication or a video communication. Alternatively, information representation section 402 may be part of the screen of map/layout chart display means 100 when information to be represented is represented by a numerical value, a character or the like. When information representation section 402 is a device for reproducing voice data or video data as information data, ID display means 430 may display a color, a character or the like associated with the ID on a light or a window provided on the device. Alternatively, when information representation section 402 is part of the screen of map/layout chart display means 100, map/layout chart display means 100 and ID display means 430 comprise the one and same device.

In this regard, in order to cause ID display means 230 and ID display means 430 to display the same color, character or the like, information representation section 402 and control device 800 may previously store a table which corresponds the ID of information representation section 402 to a color, a character or the like to be displayed, such that when ID transmitting means 422 transmits an ID, information representation section 402 may cause ID display means 430 to display a color, a character or the like corresponded to the ID with reference to the table, and when ID receiving means 222 receives an ID, control device 800 may cause ID display means 230 to display a color, a character or the like corresponded to the ID with reference to the table.

Also, in order to display the same color, character or the like on ID display means 230 and ID display means 430, when ID transmitting means 422 is instructed to send an ID and data indicative of a color associated with the ID (for example data in RGB form) or data indicative of a character (for example, data in ASCII form) to ID receiving means 222, information representation section 402 may cause ID display means 430 to display the color or character based on the data, and control device 800 may cause ID display means 230 to display the color or character based on the received data.

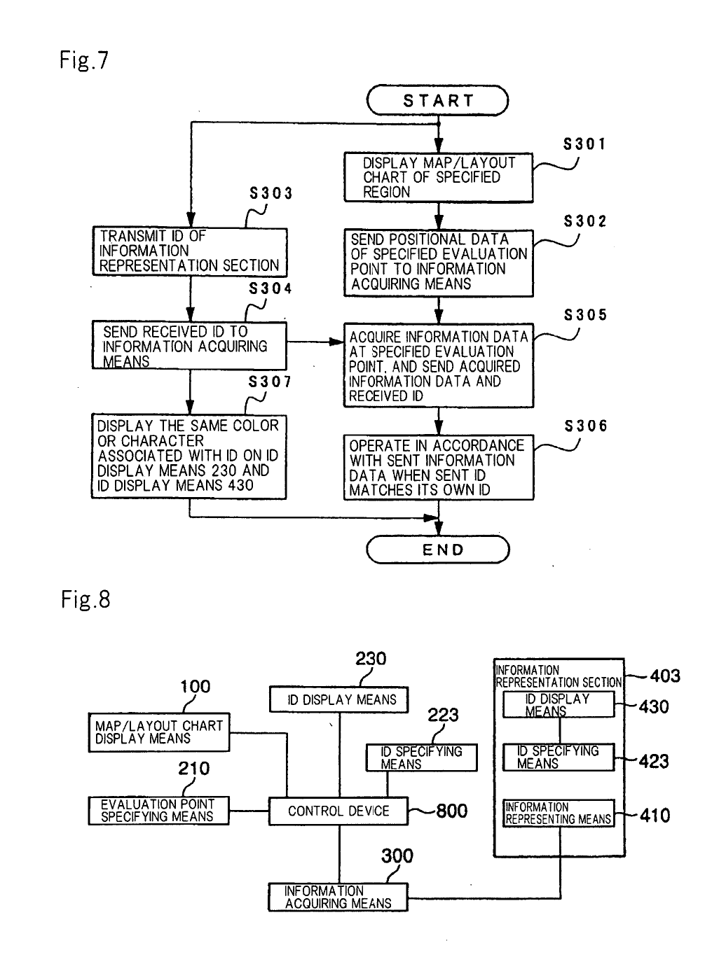

FIG. 7 is a flow chart showing the operation of the third exemplary embodiment of the position-dependent information representation system according to the present invention. First, control device 800 causes map/layout chart display means 100 to display a map or a layout chart of a region specified by an evaluator, based on map data or layout chart data corresponding to the region within map data or layout chart data (step S301).

Next, when evaluation point specifying means 210 is manipulated to specify an evaluation point, control device 800 acquires positional data indicative of the evaluation point specified by evaluation point specifying means 210 within the region of the map or layout chart displayed on map/layout chart display means 100, and sends the acquired positional data to information acquiring means 300 (step S302).

ID transmitting means 422 in turn transmits an ID for identifying information representation section 402 to ID receiving means 222 (step S303). At the time the transmission/reception of the ID is completed from ID transmitting means 422 to ID receiving means 222, ID display means 230 and ID display means 430 of information representation section 402 display the same color, character or the like associated with the ID. ID receiving means 222 receives the ID transmitted at step S303, and outputs the same to control device 800. Control device 800 sends the ID received by ID receiving means 222 to information acquiring means 300 (step S304). Control device 800 causes ID display means 230 and ID display means 430 to display a color, a character or the like associated with the ID at the time the transmission/reception of the ID is completed to information acquiring means 300 (step S307).

Information acquiring means 300 acquires information data at the evaluation point based on the positional data of the evaluation point sent at step S302. Then, information acquiring means 300 sends the acquired information data to information representing means 410 together with the ID sent at step S304 (step S305). When the ID sent at step S305 matches the ID of information representation section 402, information representing means 410 performs an operation in accordance with the information data sent at step S305 to represent the information data (step S306).

In the third exemplary embodiment, ID transmitting means 422 of information representation section 402 sends the ID of information representation section 402 to ID receiving means 222 before information data is represented, so that ID display means 230 and ID display means 430 can display the same color, character or the like.

Also, when the ID sent from information acquiring means 300 matches the ID of information representation section 402, information representing means 410 represents the information data acquired by information acquiring means 300. According to such an implementation, information data at a specified evaluation point can be represented on a corresponding information representation section based on the ID. Further, the correspondence relationship between the evaluation point and the information representation section can also be recognized by persons other than an evaluator.

Accordingly, unlike the first exemplary embodiment and second exemplary embodiment, a communication medium through which the ID and information data are transmitted/received does not have to be visually recognizable, but the ID and information data may be transmitted/received, for example, through an infrared communication, a radio communication or the like.

In the first exemplary embodiment and third exemplary embodiment, while the information representation section transmits the ID of the information representation section to the ID receiving means controlled by control device 800, the ID for identifying an evaluation point may be transmitted from control device 800 to the information representation section.

### Fourth Exemplary Embodiment

A fourth exemplary embodiment of the present invention will be described with reference to the drawings. FIG. 8 is a block diagram showing the configuration of the fourth exemplary embodiment of the position-dependent information representation system according to the present invention.

The position-dependent information representation system shown in FIG. 8 comprises control device 800 for controlling connected map/layout chart displaying means 100, evaluation point specifying means 210, ID display means 230, and ID specifying means (evaluation point ID specifying means) 223; information acquiring means 300; and information representation section 403.

In this regard, exemplary configurations and specific devices of map/layout chart display means 100, evaluation point specifying means 210, information acquiring means 300, and information representing means 410 are as shown in the description of the first exemplary embodiment.

ID specifying means 223 has a function of specifying the ID of an evaluation point in accordance with a manipulation of an evaluator. ID specifying means 223 is implemented, for example, by a button provided on evaluation point specifying means 210. ID display means 230 has a function of displaying a color, a character or the like associated with the ID when the ID is specified by ID specifying means 223.

Information representation section 403 comprises ID display means 430, ID specifying means (ID selecting means) 423, and information representing means 410. ID specifying means 423 has a function of specifying (selecting) the ID of information representation section 403 in accordance with a manipulation of the evaluator. ID specifying means 423 is implemented, for example, by a button provided on information representation section 403. ID display means 430 has a function of displaying a color, a character or the like associated with the ID at the time the ID is specified by ID specifying means 423.

In this regard, in order to cause ID display means 230 and ID display means 430 to display the same color, character or the like, information representation section 403 and control device 800 may previously store a table which corresponds the ID of information representation section 403 to a color, a character or the like to be displayed, such that when an ID is specified by ID specifying means 403, information representation section 403 may cause ID display means 430 to display a color, a character or the like corresponded to the ID with reference to the table, and when an ID is specified by ID specifying means 223, control device 800 may cause ID display means 230 to display a color, a character or the like corresponded to the ID with reference to the table.

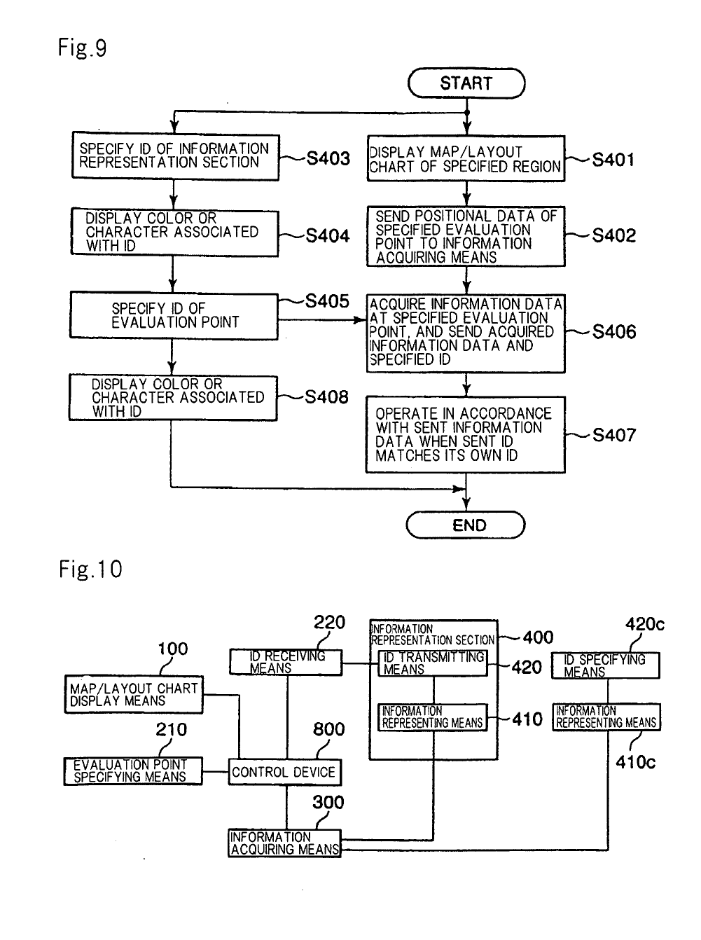

FIG. 9 is a flow chart showing the operation of the fourth exemplary embodiment of the position-dependent information representation system according to the present invention.

First, control device 800 causes map/layout chart display means 100 to display a map or a layout chart of a region specified by an evaluator, based on map data or layout chart data corresponding to the specified region within map data or layout chart data (step S401).

Next, when evaluation point specifying means 210 is manipulated to specify an evaluation point, control device 800 acquires positional data indicative of the evaluation point specified by evaluation point specifying means 210 within the region of the map or layout chart displayed on map/layout chart display means 100, and sends the acquired positional data to information acquiring means 300 (step S402).

ID specifying means 423 specifies the ID of information representation section 403 in accordance with a manipulation of the evaluator (step S403). Next, ID display means 430 of information representation section 403 displays a color, a character or the like associated with the ID specified at step S403 (step S404).

ID specifying means 223 specifies the ID of the evaluation point to the same ID as the ID of the information representation section on which the evaluator wishes to represent information data in accordance with a manipulation of the evaluator, and control device 800 sends the specified ID to information acquiring means 300 (step S405). Next, ID display means 230 displays a color, a character or the like associated with the ID specified at step S405 (step S408).

Information acquiring means 300 acquires information data at the evaluation point based on the positional data of the evaluation point sent at step S402. Then, information acquiring means sends the acquired information data to information representing means 410 together with the ID sent at step S405 (step S406). When the ID sent at step S406 matches the ID of information representation section 403, information representing means 410 performs an operation in accordance with the information data sent at step S406 to represent the information data (step S407).

In this regard, the operation of ID specifying means 423 for specifying an ID and the operation of ID display means 430 for displaying the ID (step S403 and S404) may be performed in sequence subsequent to the operation of ID specifying means 223 for specifying an ID and the operation of display means 230 for displaying the ID (steps S405 and S408). However, when the operation for representing information data is performed at step S407, it is preferable that the operation of ID specifying means 423 for specifying an ID and the operation of ID display means 430 for displaying the ID (steps S403 and S404) have been completed.

In the fourth exemplary embodiment, the same ID is assigned to information representation section 403 and to an evaluation point, so that the same color, character or the like can be displayed on ID display means 230 and ID display means 430.

Also, when the ID sent from information acquiring means 300 matches the ID of information representation section 403, information representing means 410 represents information data acquired by information acquiring means 300. With the employment of such an implementation, a corresponding information representation section can be caused to represent information data at a specified evaluation point based on the ID. Further, the correspondence relationship between the evaluation point and the information representation section can also be recognized by persons other than an evaluator.

Accordingly, unlike the first exemplary embodiment through third exemplary embodiment, it is not necessary to transmit/receive the ID and information data.

In addition, in the third exemplary embodiment and fourth exemplary embodiment, a difference resulting from whether or not an actual evaluator is evaluating information data (in other words, information representation section 403 is representing information data) may be represented by how to blink a color, a character or the like displayed on ID display means 230 and ID display means 430. In doing so, the evaluator can be allowed to recognize an operating situation of information representation section 403.

For example, in a state where the same ID has been specified for an evaluation point and an information representation section, but no information data has been represented on information representing means 410, ID display means 230 and ID display means 430 display a lit color, character or the like, and at the time information representing means 410 starts representing information data, ID display means 230 and ID display means 430 displays a blinked color, character or the like at the same timing.

In addition, in accordance with the result of evaluating information data, the information data may be represented by changing the manner a color, a character or the like is blinked as they are displayed on ID display means 230 and ID display means 430. For example, when information representing means 410 is representing good information data (for example, information data indicative of a communication quality does not indicate a delay or the existence of lost packets), ID display means 230 and ID display means 430 displays a lit color, character or the like, whereas when representing bad information data, the color, character or the like is blinked at the same timing as it is being displayed on ID display means 230 and ID display means 430. In this way, the evaluator can be allowed to recognize the result of evaluating the information data. In this regard, information acquiring means 300 determines whether information data is good or bad, for example, based on whether or not the information data indicates a delay or the existence of lost packets.

### Fifth Exemplary Embodiment

A fifth exemplary embodiment of the present invention will be described with reference to the drawings. FIG. 10 is a block diagram showing the configuration of the fifth exemplary embodiment of the position-dependent information representation system according to the present invention.

The position-dependent information representation system shown in FIG. 10 comprises control device 800 for controlling connected map/layout chart displaying means 100, evaluation point specifying means 210, and ID receiving means 220; information acquiring means 300; and information representation section 400, where information representing means 410c is connected to information acquiring means 300, and ID specifying means 420c is connected to information representing means 410c.

In this regard, exemplary configurations and specific devices of map/layout chart display means 100, evaluation point specifying means 210, ID receiving means 220, information acquiring means 300, and information representation section 400 are as shown in the description of the first exemplary embodiment.

ID specifying means 420c has a function of selecting (specifying) the ID of the information representing means in accordance with a manipulation of an evaluator, and selecting information data represented by information representing means 410c in accordance with the selected ID.

Information representing means 410c has a function of representing the information data acquired by information acquiring means 300 when the ID sent from information acquiring means 300 matches the ID selected by ID specifying means 420. A specific example of information representing means 410c is the same as the specific example of information representing means 400 shown in the description of the first exemplary embodiment. However, a device employed herein is different from information representing means 400 shown in FIG. 10.

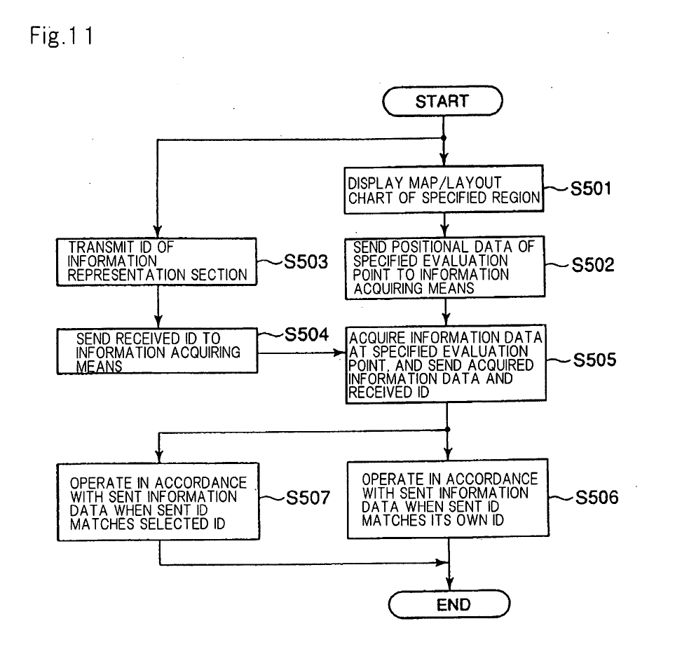

FIG. 11 is a flow chart showing the operation of the fifth exemplary embodiment of the position-dependent information representation system according to the present invention.

First, control device 800 causes map/layout chart display means 100 to display a map or a layout chart of a region specified by an evaluator, based on map data or layout chart data corresponding to the specified region within map data or layout chart data (step S501).

Next, when evaluation point specifying means 210 is manipulated to specify an evaluation point, control device 800 acquires positional data indicative of the evaluation point specified by evaluation point specifying means 210 within the region of the map or layout chart displayed on map/layout chart display means 100, and sends the acquired positional data to information acquiring means 300 (step S502).

ID transmitting means 420 in turn transmits the ID for identifying information representation section 400 to ID receiving means 220 through communication medium 500 (step S503). ID receiving means 220 receives the ID transmitted at step S503, and outputs the same to control device 800. Control device 800 sends the ID received by ID receiving means 220 to information acquiring means 300 (step S504).

Information acquiring means 300 acquires information data at the evaluation point based on the positional data of the evaluation point sent at step S502. Then, information acquiring means 300 sends the acquired information data to information representing means 410 and information representing means 410c together with the ID sent at step S504 (step S505). When the ID sent at step S505 matches the ID of information representation section 400, information representing means 410 performs an operation in accordance with the information data sent at step S505 to represent the information data (step S506).

When the ID sent at step S505 matches the ID selected by ID specifying means 420c, information representing means 410c performs an operation in accordance with the information data sent at step S505 to represent the information data (step S507).

In the fifth exemplary embodiment, another information representing means 410c different from information representing means 410 used by the evaluator is employed other than information representing means 410 for the evaluator to make an evaluation, such that persons other than the evaluator can evaluate information. Thus, information evaluated at an evaluation point can be shared with persons other than the evaluator. In this regard, while information representing means 410c and the like are added to the configuration of the first exemplary embodiment in this exemplary embodiment, information representing means 410c and the like may be added to the configuration of the second exemplary embodiment to fourth exemplary embodiment.

In each of the exemplary embodiments described above, control device 800, information acquiring means 300, and each means controlled by control device 800 may be implemented by a single device (for example, a server as control means or a position-dependent information representation control device).

### First Example

Next, the operation of the best mode for carrying out the present invention will be described using a specific example. In each of the following examples, a description will be given of a scenario where an evaluator evaluates a voice quality of a mobile telephone system using the position-dependent information representation system of each exemplary embodiment according to the present invention. In this regard, assume a scene (co-design environment) where a plurality of persons plan or design facilities for a communication network in common using a map displayed on a table.

First, a description will be given of an example for the position-dependent information representation system of the first exemplary embodiment shown in FIG. 1. Assume that a table-shaped screen is employed for map/layout chart display means 100 in the first exemplary exemplary embodiment. Assume that a tangible device capable of specifying a position by placing the same on the screen is employed for evaluation point specifying means 210. ID receiving means 220 is disposed within the tangible device. Employed as information acquiring means 300 is a quality simulation device for estimating a network quality at a specified evaluation point, and deteriorating voice data based on the estimated network quality to simulate the network quality.

An approach employed for estimating a network quality involves, for example, calculating a radio wave environment at a specified evaluation point through a simulation, and performing a traffic simulation together with traffic data. Assume that employed as information representing means 410 is an evaluation-dedicated terminal which is capable of receiving and decoding voice data. The evaluation-dedicated terminal is provided therein with ID transmitting means 420. A communication cable is used as communication medium 500.

A description will be given of the operation of the position-dependent information representation system of the first example. First, when control device 800 is manipulated by an evaluator to specify a region in which the evaluator wishes to evaluate a voice quality, a map or a layout chart of this region is displayed on the screen. Next, the evaluator places a tangible device at a position which is whereby specified as an evaluation point.

Here, as the evaluation-dedicated terminal and tangible device are connected through the communication cable, an ID is transmitted from ID transmitting means 420 within the evaluation-dedicated terminal for identifying the evaluation-dedicated terminal, and ID receiving means 220 within the tangible device receives the transmitted ID. Then, control device 800 transmits positional data of the specified evaluation point and the ID received by ID receiving means 220 to a quality simulation device.

The quality simulation device estimates a network quality at the evaluation point based on the positional data of the evaluation point, and sends evaluation data with which deterioration has been simulated and the ID to information representing means 410 of the evaluation-dedicated terminal. The evaluation-dedicated terminal receives and decodes the transmitted evaluation data when the transmitted ID matches its own ID (of the evaluation-dedicated terminal).

In this regard, when ID transmitting means 420 and ID receiving means 220 support a human body communication, the body of the evaluator can be utilized as communication medium 500. Specifically, as the evaluator grasps both the evaluation-dedicated terminal and tangible device, the ID transmitted from the evaluation-dedicated terminal is transmitted to the tangible device, thus making it possible to transmit/receive the ID.

### Second Example

A second example will be described in connection with a scenario where an evaluator evaluates a voice quality of a mobile telephone system using the position-dependent information representation system of the second exemplary embodiment shown in FIG. 4.

The same devices as those shown in the first example are used for map/layout chart display means 100, evaluation point specifying means 210, information acquiring means 300, and information representing means 410 in this example. However, the tangible device is provided therein with information transmitting means 221, while the evaluation-dedicated terminal is provided therein with information receiving means 421.

A description will be given of the operation of the position-dependent information representation system of the second example. First, when control device 800 is manipulated by an evaluator to specify a region in which the evaluator wishes to evaluate a voice quality, a map or a layout chart of this region is displayed on the screen. Next, the evaluator places a tangible device at a position which is thereby specified as an evaluation point.

Control device 800 transmits positional data of the specified evaluation point to the quality simulation device. The quality simulation device estimates a network quality at the evaluation point based on the positional data of the evaluation point, and sends evaluation data with which deterioration has been simulated to information receiving means 421 within the evaluation-dedicated terminal through information transmitting means 221 within the tangible device. As the evaluation-dedicated terminal and tangible device are connected through a communication cable, the evaluation data is transmitted to the evaluation-dedicated terminal. The evaluation-dedicated terminal receives and decodes the transmitted evaluation data.

### Third Example

A third example will be described in connection with a scenario where an evaluator evaluates a voice quality of a mobile telephone system using the position-dependent information representation system of the third exemplary embodiment shown in FIG. 6.

The same devices as those shown in the first example are used for map/layout chart display means 100, evaluation point specifying means 210, information acquiring means 300, and information representing means 410 in this example. However, the tangible device is provided with ID receiving means 222 and ID display means 230, while the evaluation-dedicated terminal is provided with ID transmitting means 422 and ID display means 430. Also, an infrared communication is used for transmission/reception of an ID performed by ID transmitting means 422 and ID receiving means 222.

First, when control device 800 is manipulated by an evaluator to specify a region in which the evaluator wishes to evaluate a voice quality, a map or a layout chart of this region is displayed on the screen. Next, the evaluator places a tangible device at a position which is whereby specified as an evaluation point.

In order to correspond the evaluation-dedicated terminal for use in evaluation to an evaluation point, ID transmitting means 422 of the evaluation-dedicated terminal transmits its ID to ID receiving means 222 of the tangible device. As the transmission/reception of the ID is completed, ID display means 230 of the tangible device and ID display means 430 of the evaluation-dedicated terminal display the same color or character.

Control device 800 transmits positional data of the specified evaluation point and the ID received by ID receiving means 222 to the quality simulation device. The quality simulation device estimates a network quality at the evaluation point based on the positional data of the evaluation point, and sends evaluation data with which deterioration has been simulated and the ID to information representing means 410 of the evaluation-dedicated terminal. The evaluation-dedicated terminal receives and decodes the transmitted evaluation data when the transmitted ID matches its own ID (of the evaluation-dedicated device).

### Fourth Example

A fourth example will be described in connection with a scenario where an evaluator evaluates a voice quality of a mobile telephone system using the position-dependent information representation system of the fourth exemplary embodiment shown in FIG. 8.

The same devices as those shown in the first example are used for map/layout chart display means 100, evaluation point specifying means 210, information acquiring means 300, and information representing means 410 in this example. However, the tangible device is provided with ID specifying means 223 and ID display means 230, while the evaluation-dedicated terminal is provided with ID specifying means 423 and ID display means 430.

First, when control device 800 is manipulated by an evaluator to specify a region in which the evaluator wishes to evaluate a voice quality, a map or a layout chart of this region is displayed on the screen. Next, the evaluator places a tangible device at a position which is whereby specified as an evaluation point.

In order to correspond the evaluation-dedicated terminal for use in evaluation to an evaluation point, assume that the same ID has been specified to ID specifying means 423 of the evaluation-dedicated terminal and to ID specifying means 223. Then, assuming that ID display means 430 of evaluation-dedicated terminal and ID display means 230 of the tangible device display a color or a character which has been previously determined in accordance with the ID, the same color or character is displayed by specifying the same ID to the ID's of both.

Control device 800 transmits positional data of the specified evaluation point and the ID specified by ID specifying means 223 to the quality simulation device. The quality simulation device estimates a network quality at the evaluation point based on the positional data of the evaluation point, and sends evaluation data with which deterioration has been simulated and the ID to information representing means 410 of the evaluation-dedicated terminal. The evaluation-dedicated terminal receives and decodes the transmitted evaluation data when the transmitted ID matches its own ID (of the evaluation-dedicated device).

### Fifth Example

A fifth example will be described in connection with a scenario where an evaluator evaluates a voice quality of a mobile telephone system using the position-dependent information representation system of the fifth exemplary embodiment shown in FIG. 10.

The same devices as those shown in the first example are used for map/layout chart display means 100, evaluation point specifying means 210, information acquiring means 300, and information representing means 410 in this example. In this regard, evaluation-dedicated terminal (for example, mobile telephone) c capable of receiving and decoding voice data is used for information representing means 410c.

First, when control device 800 is manipulated by an evaluator to specify a region in which the evaluator wishes to evaluate a voice quality, a map or a layout chart of this region is displayed on the screen. Next, the evaluator places a tangible device at a position which is whereby specified as an evaluation point.

Here, as the evaluation-dedicated terminal and tangible device are connected through a communication cable, an ID is transmitted from ID transmitting means 420 within the evaluation-dedicated terminal for identifying the evaluation-dedicated terminal, and ID receiving means 220 within the tangible device receives the transmitted ID. Then, control device 800 transmits positional data of the specified evaluation point and the ID received by ID receiving means 220 to a quality simulation device.

The quality simulation device estimates a network quality at the evaluation point based on the positional data of the evaluation point, and sends evaluation data with which deterioration has been simulated and the ID to information representing means 410 of the evaluation-dedicated terminal and to information representing means 410c of evaluation-dedicated terminal c. The evaluation-dedicated terminal receives and decodes the transmitted evaluation data when the transmitted ID matches its own ID (of the evaluation-dedicated terminal).

Likewise, evaluation-dedicated terminal c receives and decodes the transmitted evaluation data when the transmitted ID is the same as its own selected ID. Evaluation-dedicated terminal c is used by persons other than the evaluator to share the quality determined by the evaluator.

According to the present invention, the control means and position-dependent information representing means are connected through a communication medium such that the correspondence of an evaluation point to the position-dependent information representing means can be visually recognized, and relevant information is represented only by the position-dependent information representing means to which information data is transmitted through the communication medium, so that persons other than evaluators can be allowed to readily recognize at which positions the respective evaluators are evaluating information. As a result, in a situation where a plurality of persons plan or design facilities of a network in common using a map displayed on a large display, it is possible to smoothly share problems and effects resulting from a change in facilities and design conditions among members who participate in the facility planning and designing.

According to the present invention, the ID display means of the position-dependent information representing means and the display means caused to display by the control means to which a representing means ID is transmitted from the position-dependent information representing means display the same character or color, so that persons other than evaluators can be allowed to readily recognize at which positions the respective evaluators are evaluating information. As a result, in a situation where a plurality of persons plan or design facilities of a network in common using a map displayed on a large display, it is possible to smoothly share problems and effects resulting from a change in facilities and design conditions among members who participate in the facility planning and designing.

According to the present invention, when a representing means ID selected by the ID selecting means of the position-dependent information representing means is the same as an evaluation point ID specified by the evaluation point ID specifying means, the ID display means of the position-dependent information representing means and the display means caused to display by the control means display the same character or color, so that persons other than evaluators can be allowed to readily recognize at which positions the respective evaluators are evaluating information. As a result, in a situation where a plurality of persons plan or design facilities of a network in common using a map displayed on a large display, it is possible to smoothly share problems and effects resulting from a change in facilities and design conditions among members who participate in the facility planning and designing.

When a plurality of position-dependent information representing means are provided, where the information acquiring means or control means transmits information data to each position-dependent information representing means, the result of evaluating the information data can be shared by persons other than evaluators.

Also, when the ID display means is configured to display a blinked character or color in accordance with an operational situation of the position-dependent information representing means, and the control means causes the display means to display a blinked character or color in accordance with an operational situation of the position-dependent information representing means, the operational situation of the position-dependent information representing means can be readily recognized by persons other than an evaluator.

Also, when the ID display means is configured to display a blinked character or color in accordance with information data to be represented, and the control means is configured to cause the display means to display a blinked character or color in accordance with the information data, the result of evaluating the information data can be readily recognized by persons other than an evaluator.

While the present invention has been described in connection with the exemplary embodiments and examples described above, the present invention is not limited to the contents of the exemplary embodiments and examples described above. The present invention can be modified in configuration and details in a variety of manners which can be understood by those skilled in the art within the scope of the invention.

For reference, this application claims the priority based on Japanese Patent Application No. 2006-325495, filed Dec. 1, 2006, the discloser of which is herein incorporated by reference in its entirety.

### INDUSTRIAL AVAILABILITY

The present invention can be applied to a system which is used by a plurality of persons to simultaneously evaluate information, which varies depending on the position, using a map or a layout chart displayed on a display. For example, when a plurality of persons plan or design facilities of a communication network in common, the present invention can be applied as means for allowing persons other than evaluators to readily recognize to which position characteristic information evaluated by the respective evaluators corresponds.

1-29. (canceled)

30. A position-dependent information representation system for representing information in accordance with a position, characterized by comprising:
control unit for causing display unit to display a map or a layout chart of a specified region in accordance with instructions of an evaluator, and specifying an evaluation point which is a position specified by the evaluator within a display range of the map or layout chart displayed on said display unit in accordance with instructions of the evaluator; and
information acquiring unit for acquiring information data indicative of information of the evaluation point; and
wherein said node comprises position-dependent information representing unit, that is connected to said control unit through a visible communication medium, for representing the information data acquired by said information acquiring unit.

31. The position-dependent information representation system according to claim 30, wherein:
said position-dependent information representing unit includes representation unit ID transmitting unit for transmitting a representation unit ID to said control unit for distinguishing from other position-dependent information representing unit,
said representing unit ID transmitting unit transmits the representing unit ID to said control unit through the communication medium,
said information acquiring unit transmits the acquired information data and the representing unit ID received by said control unit to said position-dependent information representing unit, and
said position-dependent information representing unit represents the information data transmitted thereto when the transmitted representing unit ID matches its own representing unit ID.

32. The position-dependent information representation system according to claim 30, wherein said information acquiring unit transmits the acquired information data to said position-dependent information representing unit through the communication medium.

33. The position-dependent information representation system according to claim 30, wherein said communication medium is the evaluator.

34. A position-dependent information representation system for representing information in accordance with a position, characterized by comprising:
control unit for causing display unit to display a map or a layout chart of a specified region in accordance with instructions of an evaluator, and for specifying an evaluation point which is a position specified by the evaluator within a display range of the map or layout chart displayed on said display unit in accordance with instructions of the evaluator;
information acquiring unit for acquiring information data indicative of information of the evaluation point; and
position-dependent information representing unit for representing the information data,
wherein said position-dependent information representing unit includes representing unit ID transmitting unit for transmitting a representing unit ID to said control unit for distinguishing from other position-dependent information representing unit,
said representing unit ID transmitting unit transmits a representing unit ID to said control unit,
said information acquiring unit transmits the acquired information data and the representing unit ID transmitted to said control unit to said position-dependent information representing unit, and
said position-dependent information representing unit represents the information data transmitted thereto when the transmitted representing unit ID matches its own representing unit ID.

35. The position-dependent information representation system according to claim 34, comprising:
representing unit ID receiving unit for receiving a representing unit ID transmitted by said representing unit ID transmitting unit,
wherein said position-dependent information representing unit includes ID display unit for displaying a character or a color associated with its own representing unit ID, and
said control unit causes said display unit to display a character or a color which is the character or color associated with the representing unit ID received by said representing unit ID receiving unit and which is similar to a character or a color which is being displayed by said ID display unit.

36. The position-dependent information representation system according to claim 35, wherein:
said ID display unit starts displaying the character or color associated with its own representing unit ID when said representing unit ID transmitting unit has completed processing for transmitting the representing unit ID, and
said control unit causes said display unit to display the character or color when said representing unit ID receiving unit has completed processing for receiving the representing unit ID.

37. A position-dependent information representation system for representing information in accordance with a position, characterized by comprising:
control unit for causing display unit to display a map or a layout chart of a specified region in accordance with instructions of an evaluator, and for specifying an evaluation point which is a position specified by the evaluator within a display range of the map or layout chart displayed on said display unit in accordance with instructions of the evaluator;
evaluation point ID specifying unit for specifying an evaluation point ID for identifying an evaluation point in accordance with instructions of the evaluator;
information acquiring unit for acquiring information data indicative of information of the evaluation point; and
position-dependent information representing unit for representing the information data,
wherein said information acquiring unit transmits the acquired information data and the evaluation point ID specified by said evaluation point ID specifying unit to said position-dependent information representing unit, and
said position-dependent information representing unit includes ID selecting unit for selecting a representing unit ID for distinguishing from other position-depending information representing unit in accordance with instructions of the evaluator, and represents the information data transmitted thereto from said information acquiring unit when the evaluation point ID transmitted from said information acquiring unit matches the representing unit ID selected by said ID selecting unit.

38. The position-dependent information representation system according to claim 37, wherein:
said position-depending information representing unit includes ID display unit for displaying a character or a color associated with a representing unit ID selected by said ID selecting unit, and
said control unit causes said display unit to display a character or a color which is the character or color associated with the evaluation point ID specified by said evaluation point ID specifying unit and which is similar to a character or a color which is being displayed by said ID display unit.

39. The position-dependent information representation system according to claim 37, comprising:
a plurality of position-dependent information representing unit,
wherein each position-dependent information representing unit represents information data transmitted thereto from said information acquiring unit when the evaluation point ID transmitted from said information acquiring unit matches a representing unit ID selected by said ID selecting unit in accordance with instructions of the evaluator.

40. The position-dependent information representation system according to claim 35, wherein:
said ID display unit displays a blinked character or color in accordance with an operational situation of said position-dependent information representing unit, and
said control unit causes said display unit to display a blinked character or color in accordance with the operational situation of said position-dependent information representing unit.

41. The position-dependent information representation system according to claim 35, wherein:
said ID display unit displays a blinked character or color in accordance with information data to be represented, and
said control unit causes said display unit to display a blinked character or color in accordance with the information data represented by said position-dependent information representing unit.

42. The position-dependent information representation system according to claim 30, wherein said control unit receives information indicative of an evaluation point from a tangible device which is placed on said display unit to indicate an evaluation point, and specifies an evaluation point based on the received information.

43. A position-dependent information representation control device for providing position-dependent information representing unit with information in accordance with a position, characterized by comprising:
control unit connected to said position-dependent information representing unit through a visible communication medium, for causing display unit to display a map or a layout chart of a specified region in accordance with instructions of an evaluator, and specifying an evaluation point which is a position specified by the evaluator within a display range of the map or layout chart displayed on said display unit in accordance with instructions of the evaluator; and
information acquiring unit for acquiring information data indicative of information of the evaluation point, and transmitting the information data to said position-dependent information representing unit.

44. The position-dependent information representation device according to claim 43, wherein:
said control unit receives a representing unit ID from said position-dependent information representing unit through the communication medium for distinguishing from other position-dependent information representing unit, and
said information acquiring unit transmits the acquired information data and the representing unit ID received by said control unit to said position-dependent information representing unit.

45. The position-dependent information representation control device according to claim 43, wherein said information acquiring unit transmits the acquired information data to said position-dependent information representing unit through the communication medium.

46. The position-dependent information representation device according to claim 43, wherein said communication medium is the evaluator.

47. A position-dependent information representation control device for providing position-dependent information representing unit with information in accordance with a position, characterized by comprising:
control unit connected to position-dependent information representing unit for representing information data, for causing display unit to display a map or a layout chart of a specified region in accordance with instructions of an evaluator, and specifying an evaluation point which is a position specified by the evaluator within a display range of the map or layout chart displayed on said display unit in accordance with instructions of the evaluator;
information acquiring unit for acquiring information data indicative of information of the evaluation point; and
representing unit ID receiving unit for receiving a representing unit ID from position-dependent information representing unit for distinguishing said position-dependent information representing unit from other position-dependent information representing unit,
wherein said information acquiring unit transmits the acquired information data and the representing unit ID received by said representing unit ID receiving unit to said position-dependent information representing unit.

48. The position-dependent information representation control device according to claim 47, wherein said control unit causes said display unit to display a character or a color which is the character or color associated with the representing unit ID received by said representing unit ID receiving unit and which is similar to a character or a color which is being displayed by said position-dependent information representing unit.

49. The position-dependent information representation control device according to claim 48, wherein said control unit causes said display unit to display the character or color when said representing unit ID receiving unit has completed processing for receiving the representing unit ID.

50. A position-dependent information representation control device for providing position-dependent information representing unit with information in accordance with a position, characterized by comprising:
control means for causing display means to display a map or a layout chart of a specified region in accordance unit with instructions of an evaluator, and specifying an evaluation point which is a position specified by the evaluator within a display range of the map or layout chart displayed on said display unit in accordance with instructions of the evaluator;
evaluation point ID specifying unit for specifying an evaluation point ID for identifying an evaluation point in accordance with instructions of the evaluator; and
information acquiring unit for acquiring information data indicative of information of the evaluation point,
wherein said information acquiring unit transmits the acquired information data and the evaluation point ID specified by said evaluation point ID specifying unit to position-dependent information representing unit for representing the information data.

51. The position-dependent information representation control device according to claim 50, wherein said control unit causes said display unit to display a character or a color which is the character or color associated with the representing unit ID specified by said evaluation point ID specifying unit and which is similar to a character or a color which is being displayed by said position-dependent information representing unit.

52. The position-dependent information representation control device according to claim 48, wherein said control unit causes said display unit to display a blinked character or color in accordance with an operational situation of said position-dependent information representing unit.

53. The position-dependent information representation control device according to claim 48, wherein said control unit causes said display unit to display a blinked character or color in accordance with information data represented by said position-dependent information representing unit.

54. The position-dependent information representation control device according to claim 43, wherein said control unit receives information indicative of an evaluation point from a tangible device which is placed on said display unit to indicate an evaluation point, and specifies an evaluation point based on the received information.

55. The position-dependent information representation control device according to claim 43, wherein said information acquiring unit or said control unit transmits the information data to a plurality of position-dependent information representing unit, respectively.

56. A position-dependent information representation method for representing information in accordance with a position, characterized by comprising:
a control step, where control unit causes display unit to display a map or a layout chart of a specified region in accordance with instructions of an evaluator, and specifies an evaluation point which is a position specified by the evaluator within a display range of the map or layout chart displayed on said display unit in accordance with instructions of the evaluator;
an information acquiring step of acquiring information data indicative of information of the evaluation point; and
an information representing step, where the information data is represented by position-dependent information representing unit connected to said control unit through a visible communication medium,
wherein the information data acquired at said information acquiring step is transmitted to said position-dependent information representing unit.

57. A position-dependent information representation method for representing information in accordance with a position, characterized by comprising:
a control step of causing display unit to display a map or a layout chart of a specified region in accordance with instructions of an evaluator, and specifying an evaluation point which is a position specified by the evaluator within a display range of the map or layout chart displayed on said display unit in accordance with instructions of the evaluator;
a representing unit ID transmitting step of transmitting an representing unit ID from position-dependent information representing unit to said control unit for distinguishing from other position-dependent information representing unit;
an information acquiring step of acquiring information data indicative of to information of the evaluation point; and
an information representing step of representing the information data by said position-dependent information representing unit,
wherein said information acquiring step includes transmitting the acquired information data and the representing unit ID received by said control unit to said position-dependent information representing unit, and
said information representing step includes said position-dependent information representing unit representing the information data transmitted thereto when the transmitted representing unit ID matches its own representing unit ID.

58. A position-dependent information representation method for representing information in accordance with a position, characterized by comprising:
a control step of causing display unit to display a map or a layout chart of a specified region in accordance with instructions of an evaluator, and specifying an evaluation point which is a position specified by the evaluator within a display range of the map or layout chart displayed on said display unit in accordance with instructions of the evaluator;
an information acquiring unit for acquiring information data indicative of information of the evaluation point; and
an information representing step of representing the information data by position-dependent information representing unit,
wherein said control step includes specifying an evaluation point ID for identifying an evaluation point in accordance with instructions of the evaluator,
said information acquiring step includes transmitting the acquired information data and the evaluation point ID specified at said control step to said position-dependent information representing unit, and
said information representing step includes selecting a representing unit ID for distinguishing from other position-depending information representing unit in accordance with instructions of the evaluator, and representing the transmitted information data when the transmitted evaluation point ID matches the representing unit ID selected at said ID selecting step.
